(19) United States
(12) Patent Application Publication
(10) Pub. No.: US 2021/0135955 A1
(43) Pub. Date: May 6, 2021

(54) CONTROL APPARATUS, CONTROL SYSTEM, CONTROL METHOD OF CONTROL APPARATUS, AND RECORDING MEDIUM

(71) Applicant: NEC Corporation, Tokyo (JP)

(72) Inventors: Hiroya KANEKO, Tokyo (JP); Takanori IWAI, Tokyo (JP); Kota IWAMOTO, Tokyo (JP); Takami SATO, Tokyo (JP); Kyota HIGA, Tokyo (JP)

(73) Assignee: NEC Corporation, Tokyo (JP)

(21) Appl. No.: 16/491,957

(22) PCT Filed: Mar. 5, 2018
(86) PCT No.: PCT/JP2018/008241

§ 371 Date: Sep. 6, 2019

(30) Foreign Application Priority Data
Mar. 6, 2017 (JP) 2017-042039

(51) Int. Cl. H04L 12/24

(52) U.S. Cl. CPC H04L 41/5019; H04L 41/5003

(57) ABSTRACT

A control apparatus comprises a first operating state reception part that receives the operating state of an application as a first operating state from two or more terminals; a second operating state presuming part that presumes terminal priority and a second operating state to which the first operating state will transition for each of the terminals on the basis of the first operating state received by the first operating state reception part; an assumption determining part that specifies as a control target terminal a terminal to be controlled with the assumption that the operating state has changed before the operating state changes on the basis of the terminal priority and the second operating state; and an assumption control part that executes predetermined processing assuming that the operating state of the control target terminal has changed to the second operating state presumed by the second operating state presuming part before the operating state of the control target terminal changes.

### CROSS-REFERENCE TO RELATED APPLICATION

This application is a National Stage of International Application No. PCT/JP2018/008241 filed Mar. 5, 2018 and claims the benefit of the priority of Japanese patent application No. 2017-042039 filed on Mar. 6, 2017, the disclosures of which are incorporated herein in their entirety by reference thereto.

### TECHNICAL FIELD

The present invention relates to a control apparatus, control system, control method of control apparatus, and program.

### BACKGROUND

There is a system configuration method called a networked system in which the application logic is distributed and deployed to a plurality of different terminals and the terminals are interconnected via a network. In a networked system, the application logic deployed in each terminal works together by exchanging information with each other via the network. As a result, a plurality of pieces of application logic cooperating with each other realize the operation as a single application across the entire networked system.

In a networked system, since each piece of application logic communicates with each other via the network, QoS requirements in the network such as the bandwidth and delay have a major impact on the QoE of the application.

Therefore, there is a network QoS (Quality of Service) guarantee technology as an element technology for ensuring the quality of experience (QoE) of an application communicating via a network. By using the QoS guarantee technology, a channel that guarantees sufficient bandwidth and low latency can be provided to each application. In other words, it is effective to use the QoS guarantee technology in order to ensure the quality of experience (QoE) such as the turnaround time, etc., of an application.

Patent Literature 1 describes a system that improves the QoE of an application by controlling the communication quality according to applications running on a terminal connected to a communication network and the network usage status. The system disclosed in Patent Literature 1 guarantees QoE by determining the communication quality for each application according to the communication priority of each application.

Patent Literature 2 describes a system that controls QoS according to the video playback status at a terminal in a video distribution application. In the system disclosed in Patent Literature 2, a distribution server deduces the video playback status at a terminal using an emulator and guarantees QoE by controlling the bandwidth in the communication between the distribution server and the terminal on the basis of the deduced status.

Patent Literature 3 discloses a system that identifies the conditions of a user on the basis of information included in a communication payload of a terminal and determines a network service provided to the user from the information included in the communication payload on the basis of the identified conditions of the user. The system described in Patent Literature 3 controls the QoS of a network according to the current conditions of an application deduced on the basis of the communication payload.

### Patent Literature 1

Japanese Patent Kokai Publication No. JP2011-155600A

### Patent Literature 2

Japanese Patent Kokai Publication No. JP2016-143980A

### Patent Literature 3

Japanese Patent Kohyo Publication No. JP2013-535041A

### SUMMARY

The disclosure of each literature cited above is incorporated herein by reference thereto. The following analysis is given from the point of view of the present invention.

As described above, the QoS requirements of a network has a major impact on the QoE of an application. In other words, when the QoS requirements of a network change, so do the QoE of an application.

Here, the QoS requirements may dynamically change according to temporal changes in the operating state of an application. For instance, in the field of the IoT (Internet of Things), sensor data is intermittently transmitted/received. Further, in a server/client type image recognition system, the size of transferred data changes. It is, however, preferable that the QoE of an application be guaranteed even in a case where the operating state of an application temporally changes.

In the system described in Patent Literature 1, the communication priority of each application is determined according to the running state of each application and the communication quality of each application is determined. Therefore, the system described in Patent Literature 1 may not always be able to change QoS in a timely manner (the process is not in time) according to the transition of the operating state of an application. As a result, in the system described in Patent Literature 1, QoE may deteriorate due to the transition of the operating state of an application.

The system described in Patent Literature 2 presupposes that a server is able to emulate the video playback status on the client side (terminal) in video distribution and that the transition of the operating mode of an application can be conclusively predictable. Therefore, the system described in Patent Literature 2 cannot be applied to an application whose operating mode transitions stochastically. For instance, in a case where a terminal takes an image using a camera and the operating mode of the application is determined on the basis of information of the image taken, the operating mode of the application changes stochastically and cannot be determined conclusively. Therefore, the system described in Patent Literature 2 cannot be applied to such an application.

The system described in Patent Literature 3 deduces the conditions of an application on the basis of payload information when the application performs communication. Therefore, in the system described in Patent Literature 3, an apparatus used by a user cannot detect a change in the conditions of the application until the application actually performs communication. As a result, in the system described in Patent Literature 3, part of communication that occurs when the operating mode of the application changes is not utilized to guarantee QoS. Consequently, the system described in Patent Literature 3 may not always be able to change QoS in a timely manner (the process is not in time) for communication actually performed when changing QoS according to a change in the conditions of the application. For instance, the system described in Patent Literature 3 may not be able to change QoS in a timely manner for actual communication in an application that transmits a small amount of data intermittently. As a result, in the system described in Patent Literature 3, QoE may deteriorate when QoS is changed according to a change in the conditions of an application.

Therefore, it is an object of the present invention to provide a control apparatus, control system, control method of control apparatus, and program that contribute to suppressing the degradation of QoE due to the transition of the operating state of an application.

According to a first aspect, there is provided a control apparatus. The control apparatus comprises a first operating state reception part that receives the operating state of an application as a first operating state from two or more terminals.

Further, the control apparatus comprises a second operating state presuming part that presumes terminal priority and a second operating state to which the first operating state will transition for each of the terminals on the basis of the first operating state received by the first operating state reception part.

Further, the control apparatus comprises an assumption determining part that specifies as a control target terminal a terminal to be controlled with the assumption that the operating state has changed before the operating state changes on the basis of the terminal priority and the second operating state.

Further, the control apparatus comprises an assumption control part that executes predetermined processing assuming that the operating state of the control target terminal has changed to the second operating state presumed by the second operating state presuming part before the operating state of the control target terminal changes.

According to a second aspect, there is provided a control system. The control system is configured to include two or more terminals and a control apparatus connected to the terminals via a network.

The terminals comprise a first operating state transmission part that transmits the operating state of an application to the control apparatus.

The control apparatus comprises a first operating state reception part that receives the operating state of an application as a first operating state from each of the terminals.

Further, the control apparatus comprises a second operating state presuming part that presumes terminal priority and a second operating state to which the first operating state will transition for each of the terminals on the basis of the first operating state received by the first operating state reception part.

Further, the control apparatus comprises an assumption determining part that specifies as a control target terminal a terminal to be controlled with the assumption that the operating state has changed before the operating state changes on the basis of the terminal priority and the second operating state.

Further, the control apparatus comprises an assumption control part that executes predetermined processing assuming that the operating state of the control target terminal has changed to the second operating state presumed by the second operating state presuming part before the operating state of the control target terminal changes.

According to a third aspect, there is provided a control method of a control apparatus. The control method includes receiving the operating state of an application as a first operating state from the terminals.

Further, the control method includes presuming terminal priority and a second operating state to which the first operating state will transition for each of the terminals on the basis of the received first operating state.

Further, the control method includes specifying as a control target terminal a terminal to be controlled with the assumption that the operating state has changed before the operating state changes on the basis of the terminal priority and the second operating state.

Further, the control method includes executing predetermined processing assuming that the operating state of the control target terminal has changed to the presumed second operating state before the operating state of the control target terminal changes.

Further, the present method is tied to a particular machine, namely a control apparatus that communicates with two or more terminals via a network.

According to a fourth aspect, there is provided a program. The program is executed by a computer that controls a control apparatus communicating with two or more terminals via a network.

The program causes the computer to execute a process of receiving the operating state of an application as a first operating state from the terminals.

Further, the program causes the computer to execute a process of presuming terminal priority and a second operating state to which the first operating state will transition for each of the terminals on the basis of the received first operating state;

Further, the program causes the computer to execute a process of specifying as a control target terminal a terminal to be controlled with the assumption that the operating state has changed before the operating state changes on the basis of the terminal priority and the second operating state.

Further, the program causes the computer to execute a process of executing predetermined processing assuming that the operating state of the control target terminal has changed to the presumed second operating state before the operating state of the control target terminal changes.

Further, the present program can be stored in a computer readable recording medium. The recording medium can be a non-transient one such as a semiconductor memory, hard disk, magnetic recording medium, and optical recording medium. The present invention can be realized as a computer program product.

According to each aspect, there is provided a control apparatus, control system, control method of control apparatus, and program that contribute to suppressing the degradation of QoE due to the transition of the operating state of an application.

### BRIEF DESCRIPTION OF THE DRAWINGS

FIG. 1 is a drawing for explaining an outline of an exemplary embodiment.

FIG. 2 is a drawing showing an example of an overall configuration of a networked system.

FIG. 3 is a block diagram showing an example of an internal configuration of a terminal 103 relating to a first exemplary embodiment.

FIG. 4 is a block diagram showing an example of an internal configuration of a QoE ensuring apparatus 101 relating to the first exemplary embodiment.

FIG. 5 is a drawing showing an example of a mode transition probability DB 305.

FIG. 6 is a drawing showing an example of a mode DB 306.

FIG. 7 is a drawing showing an example of an infrastructure resource DB 307.

FIG. 8 is a drawing showing an example of a mode requirement DB 308.

FIG. 9 is a flowchart showing an example of the operation of the terminal 103 relating to the first exemplary embodiment.

FIG. 10 is a flowchart showing an example of the operation of the QoE ensuring apparatus 101 relating to the first exemplary embodiment.

FIG. 11 is a flowchart showing an example of the operation of the QoE ensuring apparatus 101 relating to the first exemplary embodiment.

FIG. 12 is a flowchart showing an example of the operation of the QoE ensuring apparatus 101 relating to the first exemplary embodiment.

FIG. 13 is a flowchart showing an example of the operation of the QoE ensuring apparatus 101 relating to the first exemplary embodiment.

FIG. 14 is a block diagram showing an example of an internal configuration of a terminal 1301 relating to a second exemplary embodiment.

FIG. 15 is a block diagram showing an example of an internal configuration of a QoE ensuring apparatus 1401 relating to the second exemplary embodiment.

FIG. 16 is a block diagram showing an example of a mode history DB 1411.

FIG. 17 is a flowchart showing an example of the operation of the terminal 1301 relating to the second exemplary embodiment.

FIG. 18 is a flowchart showing an example of the operation of the QoE ensuring apparatus 1401 relating to the second exemplary embodiment.

FIG. 19 is a block diagram showing an example of an internal configuration of a terminal 1801 relating to a third exemplary embodiment.

FIG. 20 is a block diagram showing an example of an internal configuration of a QoE ensuring apparatus 1901 relating to the third exemplary embodiment.

FIG. 21 is a flowchart showing an example of the operation of the terminal 1801 relating to the third exemplary embodiment.

FIG. 22 is a flowchart showing an example of the operation of the QoE ensuring apparatus 1901 relating to the third exemplary embodiment.

### PREFERRED MODES

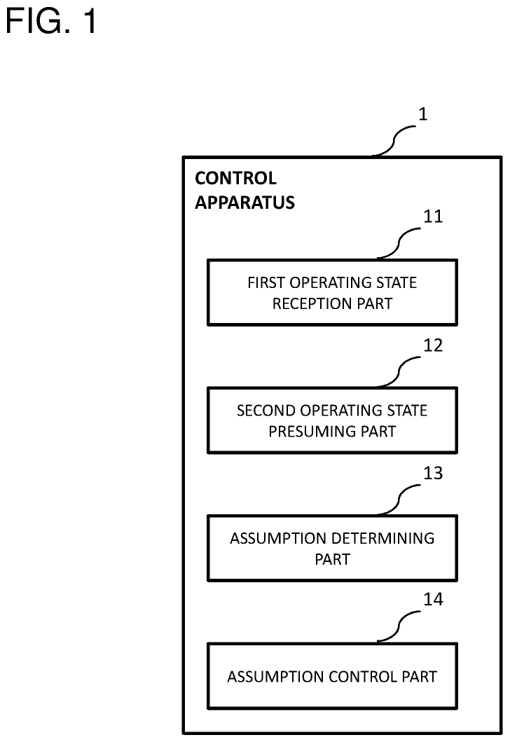

First, an outline of an exemplary embodiment will be described with reference to FIG. 1. Note that drawing reference signs in the outline are given to each element as an example solely to facilitate understanding for convenience and the description in the outline is not intended to limit the present invention in any way. Further, connection lines between blocks in each block diagram can be both bidirectional and unidirectional. Unidirectional arrows schematically indicate main flows of signals (data) and do not exclude bidirectionality.

As described above, there is a need for a control apparatus that contributes to suppressing the degradation of QoE due to the transition of the operating state of an application.

As an example, there is provided a control apparatus 1 shown in FIG. 1. The control apparatus 1 comprises a first operating state reception part 11, a second operating state presuming part 12, an assumption determining part 13, and an assumption control part 14.

The first operating state reception part 11 receives the operating state of an application as a first operating state from two or more terminals. Here, the application means application software. Further, each terminal may execute processing by running the application.

The second operating state presuming part 12 presumes terminal priority and a second operating state to which the first operating state will transition for each terminal on the basis of the first operating state received by the first operating state reception part 11. Here, the terminal priority denotes the degree of priority given to each terminal to be controlled with the assumption that the operating state of an application running on the terminal has changed before the operating state changes.

The assumption determining part 13 specifies as a control target terminal a terminal to be controlled with the assumption that the operating state has changed before the operating state changes on the basis of the terminal priority and the second operating state.

The assumption control part 14 executes predetermined processing assuming that the operating state of a control target terminal has changed to the second operating state presumed by the second operating state presuming part 12 before the operating state of the control target terminal changes. Here, the predetermined processing includes a process for guaranteeing QoE.

Therefore, the control apparatus 1 contributes to suppressing the degradation of QoE due to the transition of the operating state of an application by assuming that the operating state of a terminal has changed before the operating state changes and executing predetermined processing.

### First Exemplary Embodiment

A first exemplary embodiment will be described in more detail with reference to the drawings. In the description below, the control apparatus described above is also referred to as QoE ensuring apparatus. Further, in the description below, an operation mode that corresponds to the first operating state described above is also referred to as current mode. Further, in the description below, an operation mode that corresponds to the second operating state described above is also referred to as assumed mode. Further, in the description below, information that identifies an operation mode is referred to as operation mode ID. Further, in the description below, out of the operation mode IDs (identifiers), information that identifies the current mode and information that identifies the assumed mode are specifically referred to as current mode ID and assumed mode ID, respectively.

Further, in the description below, the first operating state reception part, the second operating state presuming part, and the assumption control part described above are referred to as mode information reception part, priority calculation part, and control information transmission part, respectively.

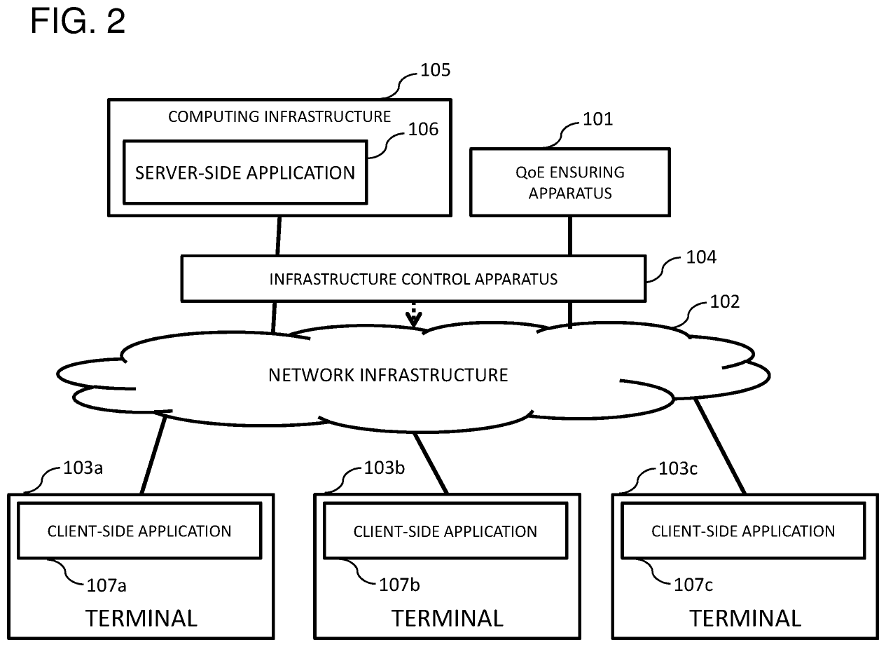

FIG. 2 is a block diagram showing an example of an overall configuration of a networked system relating to the present exemplary embodiment. The networked system relating to the present exemplary embodiment is configured to include a QoE ensuring apparatus 101, one or more terminals (103a to 103c), an infrastructure control apparatus 104, and a computing infrastructure 105. Further, the terminals (103a to 103c) are connected to the QoE ensuring apparatus 101 and the computing infrastructure 105 via a network infrastructure 102 and the infrastructure control apparatus 104. Further, in the following description, the terminals (103a to 103c) are collectively referred to as the terminal 103 when there is no need to distinguish one from another. Note that, although FIG. 2 shows three terminals (103a to 103c), the number of the terminals 103 is not limited to three. The networked system relating to the present exemplary embodiment may be configured to include one or two, or four or more terminals. Furthermore, in the following description, the network infrastructure 102 and the computing infrastructure 105 are also referred to as the “infrastructure.”

The QoE ensuring apparatus 101 is an apparatus (computer) that executes and controls a process for ensuring QoE in an application running in the networked system. The QoE ensuring apparatus 101 is configured to include a CPU (Central Processing Unit), a memory, communication means, etc. The details of the QoE ensuring apparatus 101 will be described later.

The terminal 103 is an apparatus (computer) used by a user. The terminal 103 is configured to include a CPU, a memory, communication means, etc. Further, the terminal 103 comprises one or more pieces of application software (client-side applications 107a to 107c shown in FIG. 2) and executes the application software. The details of the terminal 103 will be described later. Further, in the following description, the client-side applications 107a to 107c are collectively referred to as the client-side application 107 when there is no need to distinguish one from another.

The network infrastructure 102 is configured to include one or more network devices (router, gateway, firewall, load balancer, etc.) that performs and controls network functions.

The computing infrastructure 105 is configured to include one or more apparatuses (computers) that function as servers providing an application to the terminal 103. Each apparatus constituting the computing infrastructure 105 is configured to include a CPU, memory, communication means, etc. Further, each apparatus constituting the computing infrastructure 105 comprises one or more pieces of application software (a server-side application 106 shown in FIG. 2) and execute the application software.

The infrastructure control apparatus 104 is an apparatus (computer) that relays and controls processing between the computing infrastructure 105 and the QoE ensuring apparatus 101, and the network infrastructure 102. The infrastructure control apparatus 104 is configured to include a CPU, memory, communication means, etc.

The server-side application 106 and the client-side application 107 are configured to include a plurality (two or more) of operating modes. The server-side application 106 and the client-side application 107 determine what processing they execute on the basis of the operating mode. Further, in the description below, “changing operating mode” is referred to as “transitioning operating mode.”

Further, each operating mode may be independent of other operating modes. Further, the operating mode of the server-side application 106 and the client-side application 107 transitions from one to another stochastically. In other words, the computing infrastructure 105 and the terminal 103 are able to presume the transition probability of an operating mode state.

Next, the internal configuration of the terminal 103 will be described.

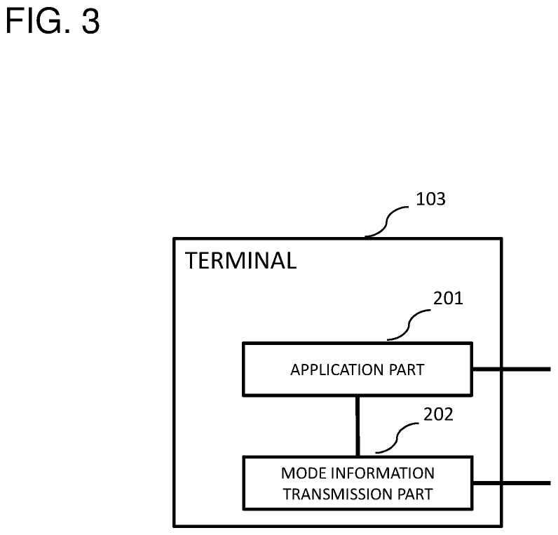

FIG. 3 is a block diagram showing an example of an internal configuration of the terminal 103 relating to the present exemplary embodiment. The terminal 103 is configured to include an application part 201 and a mode information transmission part (also referred to as first operating state transmission part) 202. Further, FIG. 3 shows modules relating to the terminal 103 relating to the present exemplary embodiment. It goes without saying that the terminal 103 may include a module not shown in the drawing.

For instance, a storage device (not shown in the drawing) provided in the terminal 103 may store the client-side application 107. The storage device is realized by a magnetic disk device, optical disk device, or semiconductor memory.

The terminal 103 may implement the application part 201 and the mode information transmission part 202 using a CPU. Further, for instance, the terminal 103 may exchange data (information) with the other apparatuses (the QoE ensuring apparatus 101, the network infrastructure 102, and the computing infrastructure 105) using a NIC (Network Interface Card).

The application part 201 executes and controls the application software (the client-side application 107) running on the terminal 103. Specifically, the application part 201 reads the client-side application 107 from the storage device (not shown in the drawing) provided in the terminal 103 and executes and controls the client-side application 107.

Further, the application part 201 exchanges data (information) with the application (the server-side application 106) executed by the server via the network infrastructure 102.

Further, in the following description, the operating mode of the application software (the client-side application 107) running on the terminal 103 is referred to as “the operating mode of the application part 201.” In other words, the running operating mode of the application part 201 corresponds to the current mode described above.

The mode information transmission part 202 notifies the QoE ensuring apparatus 101 of the operating state of the application part 201 as the first operating state. Here, the operating state includes a plurality of discrete operating modes of an application.

Further, the first operating state includes the operating mode (the current mode) running in an application and the state transition probability between the operating modes.

In other words, the mode information transmission part 202 notifies the QoE ensuring apparatus 101 of the current mode and the state transition probability between the operating modes as the first operating state. More specifically, the mode information transmission part 202 collects information on the current mode and the state transition probability between the operating modes. Then the mode information transmission part 202 notifies the QoE ensuring apparatus 101 of the collected operating mode and state transition probability between the operating modes via the network infrastructure 102.

Next, the internal configuration of the QoE ensuring apparatus 101 will be described in detail.

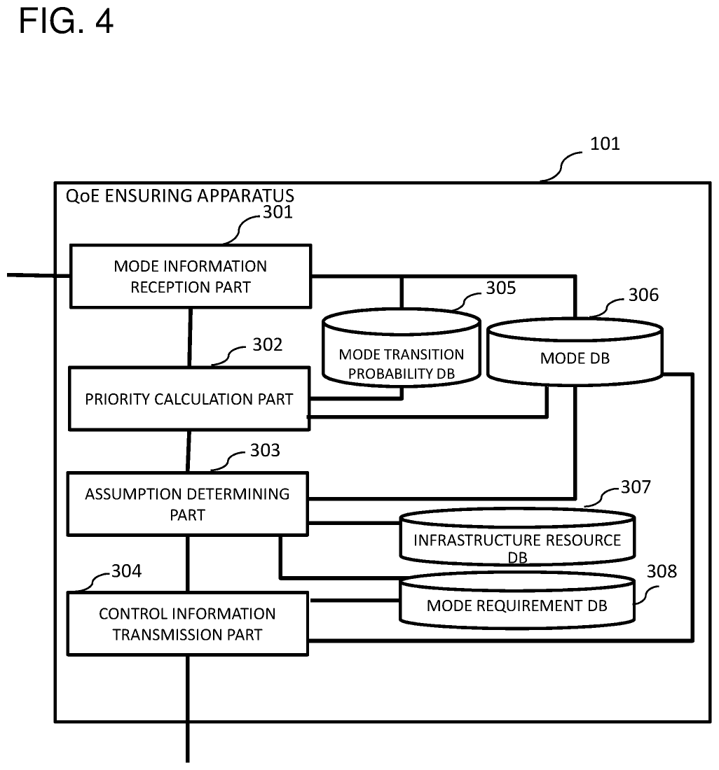

FIG. 4 is a block diagram showing an example of an internal configuration of the QoE ensuring apparatus 101 relating to the present exemplary embodiment. The QoE ensuring apparatus 101 is configured to include a mode information reception part (first operating state reception part) 301, a priority calculation part (second operating state presuming part) 302, an assumption determining part 303, and a control information transmission part (assumption control part) 304. Further, the QoE ensuring apparatus 101 is configured to include a mode transition probability DB (database) (also referred to as operating mode transition probability database) 305, a mode DB (also referred to as operating mode database) 306, an infrastructure resource DB (also referred to as infrastructure resource database) 307, and a mode requirement DB (also referred to as operating mode requirement database) 308.

For instance, a storage device (not shown in the drawing) provided in the QoE ensuring apparatus 101 may store the mode transition probability DB 305, the mode DB 306, the infrastructure resource DB 307, and the mode requirement DB 308. The storage device is realized by a magnetic disk device, optical disk device, or semiconductor memory.

Further, the QoE ensuring apparatus 101 may implement the mode information reception part 301, the priority calculation part 302, the assumption determining part 303, and the control information transmission part 304 using a CPU. Further, for instance, the QoE ensuring apparatus 101 may exchange data (information) with the other apparatuses (the terminal 103, the infrastructure control apparatus 104, etc.) using a NIC.

The mode transition probability DB 305 stores information identifying a terminal 103, information identifying an operating mode, and the state transition probability of transitioning to the operating mode while associating these pieces of information with each other. In other words, for each terminal 103, the mode transition probability DB 305 associates possible operating modes of the application part 201 with the probabilities (the state transition probabilities) of transitioning to these operating modes, and stores this information.

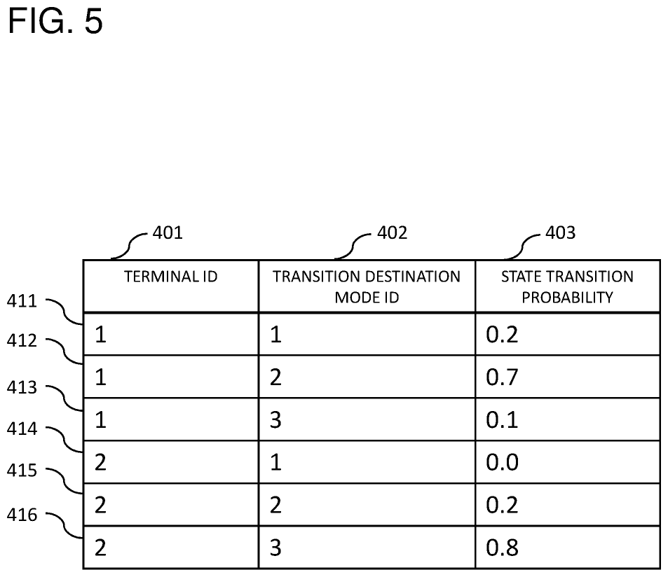

FIG. 5 is a drawing showing an example of the mode transition probability DB 305. More specifically, FIG. 5 shows a table in which terminal ID 401, transition destination mode ID 402, and the state transition probability 403 are associated with each other. The terminal ID 401 is the information identifying a terminal 103. The transition destination mode ID 402 is the information identifying a possible operating mode of the application part 201. The state transition probability 403 indicates the probability that, in the terminal 103 indicated by the corresponding the terminal ID 401, an operating mode of the application part 201 changes to (transitions to) the operating mode indicated by the corresponding transition destination mode ID 402. Here, the mode transition probability DB 305 shown in FIG. 5 shows entries 411 to 416 associating the terminal ID 401, the transition destination mode ID 402, and the state transition probability 403 with each other.

For instance, the entry 411 shown in FIG. 5 indicates that the probability of transitioning to an operating mode having a transition destination mode ID of 1 is 0.2 in a terminal 103 having a terminal ID of 1.

The mode DB 306 stores information identifying a terminal 103, the operating mode of the first operating state (the current mode), the operating mode of the second operating state (the assumed mode), the terminal priority, and information (referred to as assumption flag hereinafter) indicating whether or not a terminal in question is a control target terminal while associating these pieces of information with each other. As described above, the terminal priority is the degree of priority given to the terminal 103 to be controlled with the assumption that the operating state has changed before the operating state changes. It indicates that it is preferable that a terminal 103 with a higher degree of the terminal priority be preferentially selected as a control target terminal. In the following description, the value of the assumption flag indicating a control target terminal is “Y.” Further, in the following description, the value of the assumption flag indicating a non-control target terminal is “N.”

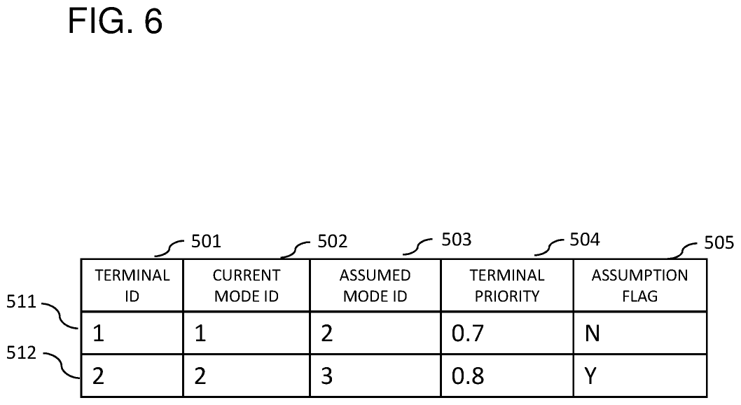

FIG. 6 is a drawing showing an example of the mode DB 306. More specifically, FIG. 6 shows a table in which terminal ID 501, current mode ID 502, assumed mode ID 503, the terminal priority 504, and the assumption flag 505 are associated with each other. Here, the mode DB 306 shown in FIG. 6 includes entries 511 and 512 associating the terminal ID 501, the current mode ID 502, the assumed mode ID 503, the terminal priority 504, and the assumption flag 505 with each other.

For instance, the entry 511 shown in FIG. 6 indicates that a terminal 103 having a terminal ID of 1 is operating in an operating mode having a current mode ID of 1 and that this operating mode will transition to an operating mode having an assumed mode ID of 2. Further, the entry 511 shown in FIG. 6 indicates that the degree of priority (terminal priority) given to the terminal 103 having the terminal ID of 1 is 0.7. The degree of priority (terminal priority) is given to the terminals 103 to be controlled with the assumption that the operating state has changed before the operating state changes. Further, the entry 511 shown in FIG. 6 indicates that the terminal 103 having the terminal ID of 1 is not a control target terminal.

The infrastructure resource DB 307 stores information regarding the resources of the network infrastructure 102 and/or the computing infrastructure 105. “And/or” means that at least one of the two mentioned is included. More specifically, the infrastructure resource DB 307 stores the total amount of resources and the resource usage (or remaining resources) of the network infrastructure 102 and/or the computing infrastructure 105 while associating these pieces of information with each other.

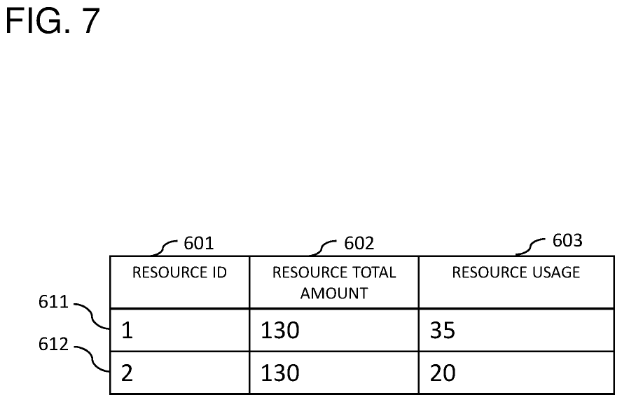

FIG. 7 is a drawing showing an example of the infrastructure resource DB 307. More specifically, FIG. 7 shows a table in which resource ID 601, resource total amount 602, and resource usage 603 are associated with each other. Here, the resource ID is information identifying a resource. Further, the infrastructure resource DB 307 shown in FIG. 7 includes entries 611 and 612 associating the resource ID 601, the resource total amount 602, and the resource usage 603 with each other. It is a matter of course that the unit of the resource usage 603 depends on the type of the corresponding resource.

For instance, the entry 611 shown in FIG. 7 indicates that a resource having a resource ID 601 of “1” has the resource total amount of “130” and the resource usage thereof is “35.”

The mode requirement DB 308 stores information regarding the requirements for executing the operating mode of the application part 201. More specifically, the mode requirement DB 308 stores information identifying an operating mode (operating mode ID), information identifying a resource (resource ID), and the amount of the resource required to execute the operating mode while associating these pieces of information with each other. In the description below, the amount of the relevant resource required to execute an operating mode is referred to as the required resource amount.

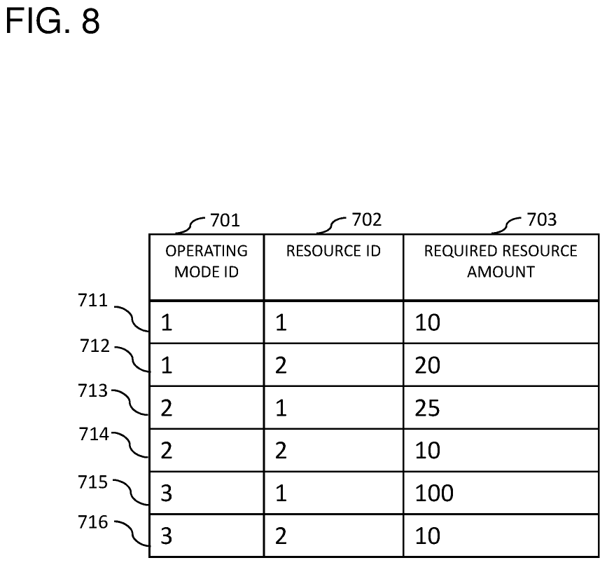

FIG. 8 is a drawing showing an example of the mode requirement DB 308. More specifically, FIG. 8 shows a table in which operating mode ID 701, resource ID 702, and the required resource amount 703 are associated with each other. Further, the mode requirement DB 308 shown in FIG. 8 includes entries 711 to 716 associating the operating mode ID 701, the resource ID 702, and the required resource amount 703 with each other. Note that it is a matter of course that the unit of the required resource amount 703 depends on the type of the corresponding resource.

For instance, the entry 711 shown in FIG. 8 indicates that an operating mode having an operating mode ID of 1 requires an amount of “10” of a resource having a resource ID of 1. Further, the entry 712 shown in FIG. 8 indicates that the operating mode having the operating mode ID of 1 requires an amount of “20” of a resource having a resource ID of 2.

The mode information reception part 301 receives the operating state of an application from one or more terminals 103 as the first operating state. More specifically, the mode information reception part 301 receives information on the current mode and the state transition probability between the operating modes as the first operating state from one or more terminals 103. Then the mode information reception part 301 stores the received current mode and state transition probability in the mode transition probability DB 305 and the mode DB 306. Further, the mode information reception part 301 notifies the priority calculation part 302 that the current mode and the state transition probability have been received.

The priority calculation part 302 presumes, for each terminal 103, the terminal priority and the second operating state to which the first operating state transitions on the basis of the first operating state received by the mode information reception part 301. More specifically, the priority calculation part 302 presumes the terminal priority and the second operating state on the basis of the state transition probability between the operating modes received by the mode information reception part 301.

Here, the second operating state includes the operating mode to which the current mode transitions in the application part 201. As described above, the operating mode corresponding to the second operating state is referred to as the assumed mode. Therefore, the priority calculation part 302 presumes the terminal priority and the assumed mode for each terminal 103 on the basis of the current mode and the state transition probability between the operating modes.

More specifically, the priority calculation part 302 presumes (calculates) the terminal priority and the assumed mode on the basis of the current mode and the state transition probability between the operating modes received by the mode information reception part 301 by referring to the mode transition probability DB 305 and the mode DB 306. Then the priority calculation part 302 stores the presumed (calculated) terminal priority and the information (the assumed mode ID) identifying the presumed (calculated) assumed mode in the mode transition probability DB 305 and the mode DB 306. In other words, the priority calculation part 302 updates the terminal priority and the assumed mode ID stored in the mode transition probability DB 305 and the mode DB 306. Then the priority calculation part 302 notifies the assumption determining part 303 that the mode transition probability DB 305 and the mode DB 306 have been updated.

The assumption determining part 303 specifies as a control target terminal a terminal to be controlled with the assumption that the operating state has changed before the operating state changes on the basis of the terminal priority and the second operating state. More specifically, the assumption determining part 303 specifies as a control target terminal a terminal to be controlled with the assumption that the operating state has changed before the operating state changes on the basis of the terminal priority and the assumed mode.

More specifically, the assumption determining part 303 refers to the mode DB 306, the infrastructure resource DB 307, and the mode requirement DB 308. Then the assumption determining part 303 determines whether or not to control each terminal 103 with the assumption that the operating state has changed before the operating state changes on the basis of the terminal priority and the assumed mode.

Then, in the mode DB 306, the assumption determining part 303 registers a flag (the assumption flag) indicating whether or not a terminal 103 is a control target terminal to be controlled with the assumption that the operating state has changed before the operating state changes. In other words, the assumption determining part 303 updates the assumption flag in the mode DB 306. Then the assumption determining part 303 notifies the control information transmission part 304 that the assumption flag in the mode DB has been updated.

Before the operating state of a control target terminal changes, the control information transmission part 304 assumes that the operating state of the control target terminal has changed to the second operating state presumed by the priority calculation part 302 and executes predetermined processing. Specifically, the control information transmission part 304 assumes that the operating mode of the control target terminal has changed to the assumed mode corresponding to the control target terminal before the operating state of the control target terminal changes, and executes predetermined processing.

More specifically, the control information transmission part 304 refers to the mode DB 306 and the mode requirement DB 308, and calculates parameters for controlling the network infrastructure 102 and/or the computing infrastructure 105. Then the control information transmission part 304 transmits the calculated parameters and an instruction to update parameters as control information to the network infrastructure 102 and/or the computing infrastructure 105.

Next, the operation of the networked system relating to the present exemplary embodiment will be described.

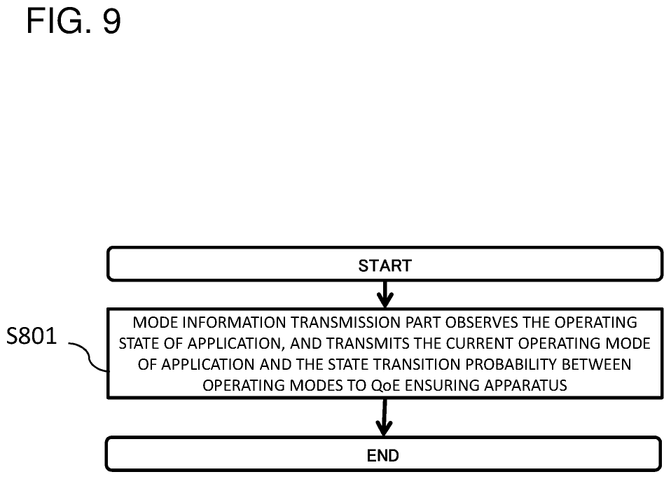

First, the operation of the terminal 103 will be described with reference to FIG. 9. FIG. 9 is a flowchart showing an example of the operation of the terminal 103.

The mode information transmission part 202 observes the operating state of an application, and transmits the current mode of the application and the state transition probability between the operating modes to the QoE ensuring apparatus 101 (step S801). More specifically, the mode information transmission part 202 obtains the operating mode running in the application part 201 as the current mode. Then the mode information transmission part 202 transmits the information (the current mode ID) identifying the current mode obtained and the state transition probability between the operating modes to the QoE ensuring apparatus 101 via the network infrastructure 102.

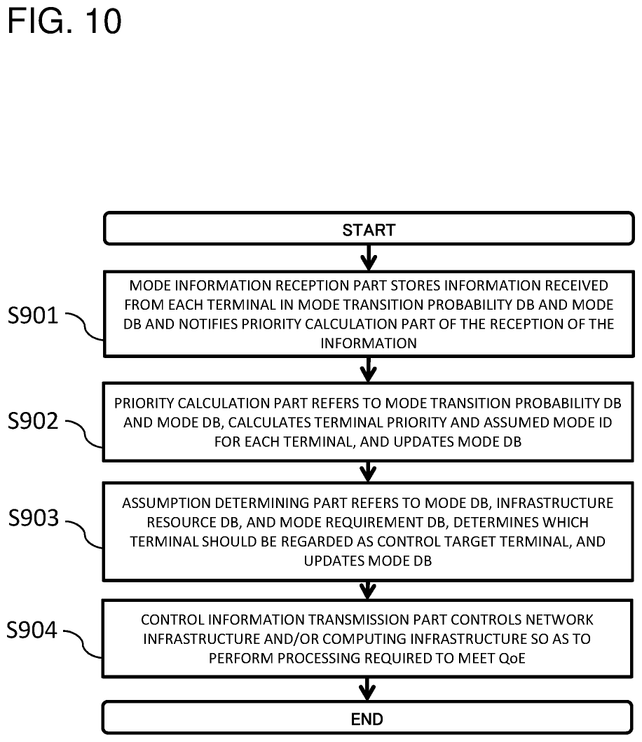

Next, the operation of the QoE ensuring apparatus 101 will be described with reference to FIGS. 10 to 13.

In the following description, the mode transition probability DB 305 may store one or more entries associating the terminal ID, the transition destination mode ID, and the state transition probability with each other. In the following description also, the mode DB 306 may store one or more entries associating the terminal ID, the current mode ID, the assumed mode ID, the terminal priority, and the assumption flag with each other. Further, in the following description, the infrastructure resource DB 307 may store one or more entries associating the resource ID, the resource total amount, and the resource usage with each other. In the following description also, the mode requirement DB 308 may store one or more entries associating the operating mode ID, the resource ID, and the required resource amount with each other.

FIG. 10 is a flowchart showing an example of the operation of the QoE ensuring apparatus 101.

In step S901, the mode information reception part 301 stores information received from each terminal 130 (103?) in the mode transition probability DB 305 and the mode DB 306 and notifies the priority calculation part 302 of the reception of the information. More specifically, the mode information reception part 301 receives the information (the current mode ID) identifying the current mode of an application running on the terminal 103 and the state transition probability between the operating modes from the terminal 103. Then the mode information reception part 301 registers (or updates) the state transition probability between the operating modes in the mode transition probability DB 305. Further, the mode information reception part 301 registers (or updates) the received current mode ID in the mode DB 306. Then the mode information reception part 301 notifies the priority calculation part 302 of the reception of the current mode ID and the state transition probability between the operating modes.

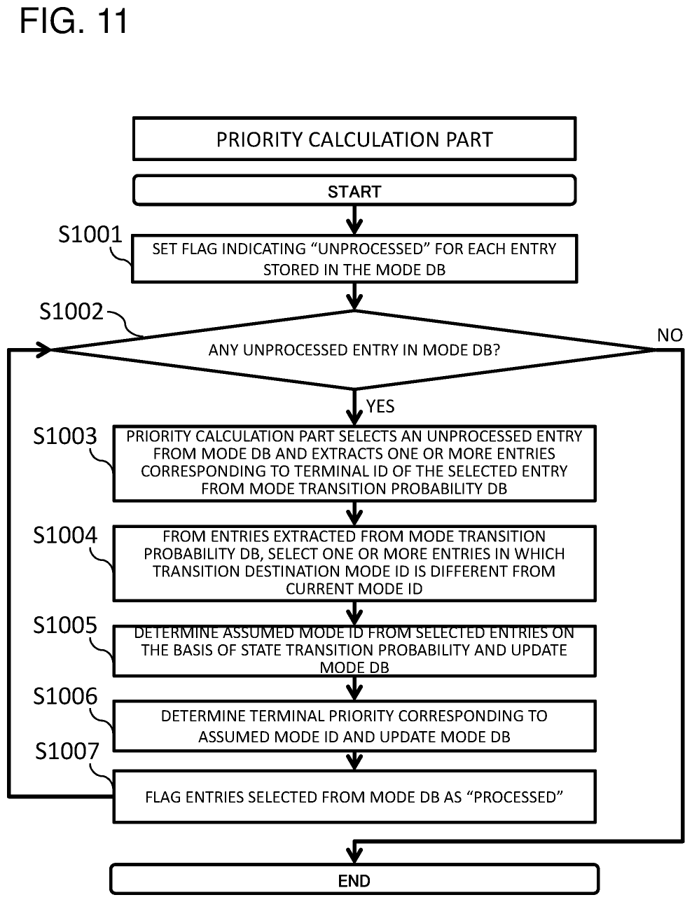

In step S902, the priority calculation part 302 refers to the mode transition probability DB 305 and the mode DB 306, calculates the terminal priority and the assumed mode ID, and updates the mode DB 306. The operation of the priority calculation part 302 will be described in detail with reference to FIG. 11.

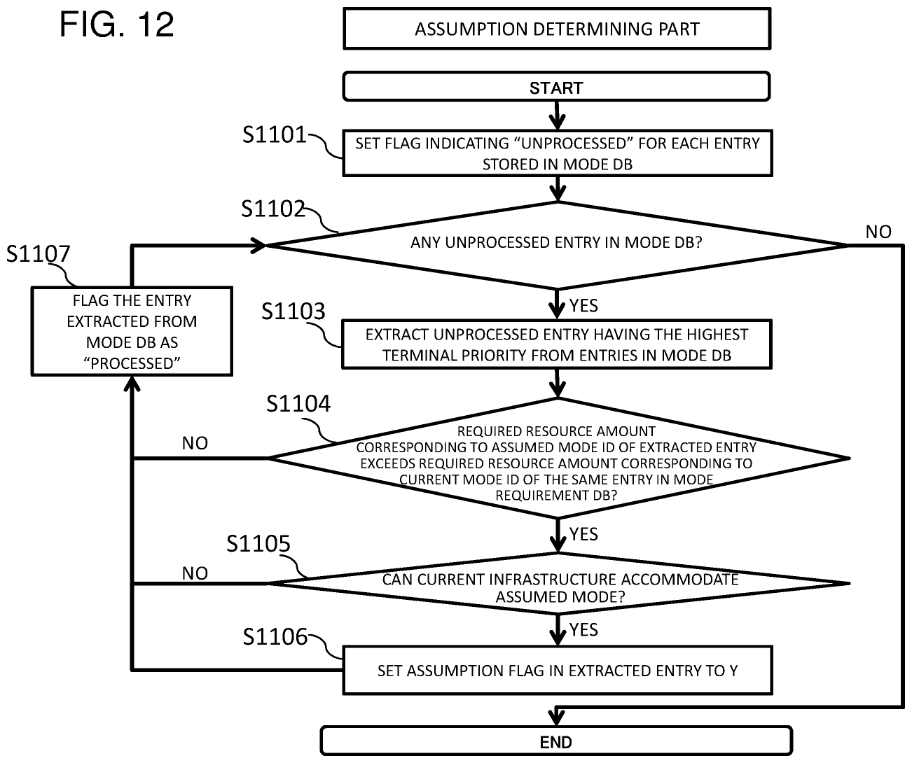

In step S903, the assumption determining part 303 refers to the mode DB 306, the infrastructure resource DB 307, and the mode requirement DB 308, determines which terminal 103 should be regarded as a control target terminal, and updates the mode DB 306. The operation of the assumption determining part 303 will be described in detail with reference to FIG. 12.

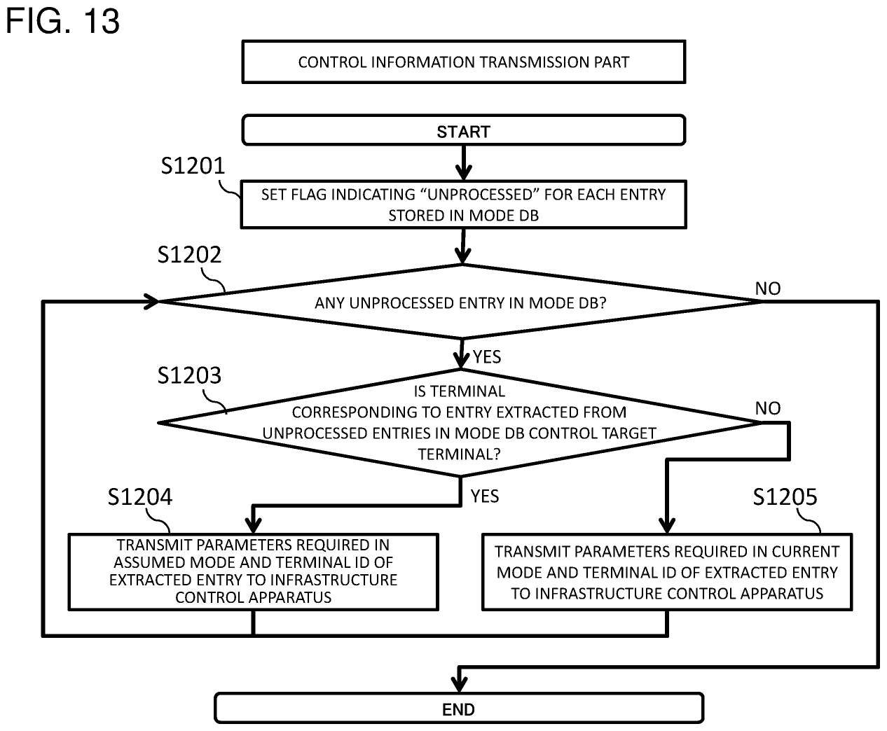

In step S904, the control information transmission part 304 controls the network infrastructure 102 and/or the computing infrastructure 105 so as to perform processing required to meet QoE. The operation of the control information transmission part 304 will be described in detail with reference to FIG. 13.

Next, the operation of the priority calculation part 302 will be described in detail with reference to FIG. 11. FIG. 11 is a flowchart showing an example of the operation of the priority calculation part 302.

In step 1001, the priority calculation part 302 sets a flag indicating “unprocessed” for each entry stored in the mode DB 306. More specifically, all the entries stored in the mode DB 306 are extracted. Then the priority calculation part 302 sets the flag indicating “unprocessed” for each of the extracted entries. As described above, the entries stored in the mode DB 306 are the information associating the terminal ID, the current mode ID, the assumed mode ID, the terminal priority, and the assumption flag with each other.

In step S1002, the priority calculation part 302 determines whether or not there is any unprocessed entry in the mode DB 306. In other words, the priority calculation part 302 determines if there is any entry flagged as “unprocessed” in the mode DB 306. When there is an unprocessed entry in the mode DB 306 (Yes in the step S1002), the operation proceeds to step S1003. Conversely, when there is no unprocessed entry in the mode DB 306 (No in the step S1002), the priority calculation part 302 determines that all the entries in the mode DB 306 have been processed and ends the processing. Then the operation proceeds to the step S903 in FIG. 10.

In step S1003, the priority calculation part 302 selects an unprocessed entry from the mode DB 306 and extracts one or more entries corresponding to the terminal ID of the selected entry from the mode transition probability DB 305.

For instance, the priority calculation part 302 may extract the entry 511 shown in FIG. 6 as an unprocessed entry from the mode DB 306. Here, the terminal ID of the entry 511 in FIG. 6 is 1. Therefore, the priority calculation part 302 extracts entries having the terminal ID of 1 from the mode transition probability DB 305 shown in FIG. 5. More specifically, the priority calculation part 302 extracts the entries 411 to 413 from the mode transition probability DB 305 shown in FIG. 5.

In step S1004, from the entries extracted from the mode transition probability DB 305, the priority calculation part 302 selects one or more entries in which the transition destination mode ID and the current mode ID are different from each other.

For instance, the priority calculation part 302 may extract the entry 511 shown in FIG. 6 from the mode DB 306 in the process of the step S1003 and the priority calculation part 302 further extracts the entries 411 to 413 from the mode transition probability DB 305 shown in FIG. 5 in the process of the step S1003. In this case, the current mode

ID of the entry 511 in FIG. 6 is 1. Therefore, in the process of the step S1004, the priority calculation part 302 selects entries not having the transition destination mode ID of 1 from the entries 411 to 413 extracted from the mode transition probability DB 305 in FIG. 5. In other words, the priority calculation part 302 selects the entries 412 and 413 shown in FIG. 5 in the process of the step S1004.

In step S1005, the priority calculation part 302 determines the assumed mode ID from the selected entries on the basis of the state transition probability and updates the mode DB 306. For instance, the priority calculation part 302 may determine the transition destination mode ID having the largest corresponding state transition probability among the selected entries to be the assumed mode ID. Then the priority calculation part 302 registers the determined assumed mode ID in the mode DB 306. Note that determining the transition destination mode ID having the largest state transition probability to be the assumed mode ID is an example of the method for determining the assumed mode ID, and the method for determining the assumed mode ID is not limited thereto.

For instance, the entries 412 and 413 shown in FIG. 5 may be selected in the process of the step S1004. In this case, the state transition probability values of the entries 412 and 413 in FIG. 5 are 0.7 and 0.1, respectively. Here, the priority calculation part 302 may determine the transition destination mode ID having the largest state transition probability to be the assumed mode ID. In this case, the priority calculation part 302 determines that a transition destination mode ID of 2 in the entry 412 is the assumed mode ID in the process of the step S1005. Then, as shown in FIG. 6, the priority calculation part 302 registers the determined assumed mode ID “2” as the assumed mode ID of the entry 511.

In step S1006, the priority calculation part 302 determines the terminal priority corresponding to the assumed mode ID and updates the mode DB 306. For instance, the priority calculation part 302 may determine the state transition probability, which is the factor for determining the assumed mode ID, to be the terminal priority. Note that this is an example of the method for determining the terminal priority, and the method for determining the terminal priority is not limited thereto.

For instance, the priority calculation part 302 determines that the transition destination mode ID “2” of the entry 412 in FIG. 5 is the assumed mode ID in the process of the step S1005. Then, the priority calculation part 302 may determine the state transition probability, which is the factor for determining the assumed mode ID, to be the terminal priority. In this case, the priority calculation part 302 determines that the state transition probability “0.7” of the entry 412 shown in FIG. 5 is the terminal priority in the process of the step S1006. Then the priority calculation part 302 registers “0.7” as the terminal priority of the entry 511 as shown in FIG. 6.

Then the operation returns to the step S1002 and the process continues. In other words, the process continues until all the entries in the mode DB 306 are flagged as processed. The priority calculation part 302 updates the assumed mode ID and the terminal priority stored in the mode DB 306 by executing the processing described above (the processing shown in FIG. 11).

Next, the operation of the assumption determining part 303 will be described in detail with reference to FIG. 12. FIG. 12 is a flowchart showing an example of the operation of the assumption determining part 303.

In step S1101, the assumption determining part 303 sets a flag indicating “unprocessed” for each entry stored in the mode DB 306. More specifically, all the entries stored in the mode DB 306 are extracted. Then the priority calculation part 302 sets the flag indicating “unprocessed” for each of the extracted entries.

In step S1102, the assumption determining part 303 determines whether or not there is any unprocessed entry in the mode DB 306. In other words, the assumption determining part 303 determines if there is any entry flagged as “unprocessed” in the mode DB 306. When there is an unprocessed entry in the mode DB 306 (Yes in the step S1102), the operation proceeds to step S1103. Conversely, when there is no unprocessed entry in the mode DB 306 (No in the step S1102), the assumption determining part 303 determines that all the entries in the mode DB 306 have been processed and ends the processing. Then the operation proceeds to the step S904 in FIG. 10.

In step S1103, the assumption determining part 303 extracts the unprocessed entry having the highest terminal priority from the entries in the mode DB 306. More specifically, the assumption determining part 303 extracts entries flagged as “unprocessed” from the mode DB 306. Then, from the extracted entries, the assumption determining part 303 further extracts the entry having the highest terminal priority as an assumption target entry.

For instance, the terminal ID, the current mode ID, the assumed mode ID, and the terminal priority may be set in the mode DB 306 as shown in FIG. 6 and that the entries 511 and 512 are flagged as “not set” in the mode DB 306 in FIG. 6. Further, the assumption flag may not be set in the mode DB 306 in the step S 1103. Here, as shown in FIG. 6, the terminal priority values of the entries 511 and 512 are 0.7 and 0.8, respectively. Therefore, the assumption determining part 303 extracts the entry 512 shown in FIG. 6 as an assumption target entry.

In step S1104, the assumption determining part 303 determines whether or not the required resource amount corresponding to the assumed mode ID of the extracted entry exceeds the required resource amount corresponding to the current mode ID of the same entry in the mode requirement DB 308. When the required resource amount corresponding to the assumed mode ID of the entry exceeds the required resource amount corresponding to the current mode ID of the same entry (Yes in the step S1104), the operation proceeds to step S1105. Conversely, when the required resource amount corresponding to the assumed mode ID of the entry does not exceed the required resource amount corresponding to the current mode ID of the same entry (No in the step S1104), the assumption determining part 303 flags the entry extracted from the mode DB 306 as “processed” (step S1107). Then the operation returns to the step 1102 and the processing continues.

For instance, the assumption determining part 303 extracts the entry 512 shown in FIG. 6 as an assumption target entry. In this case, the current mode ID and the assumed mode ID of the extracted entry 512 are 2 and 3, respectively.

Here, the mode requirement DB 308 in FIG. 8 shows that the total amount of the required resources corresponding to an operating mode ID of 2 (corresponding to the current mode ID of the entry 512 in FIG. 6) is 35 (25 (the required resource amount of the entry 713)+10 (the required resource amount of the entry 714). Therefore, the assumption determining part 303 determines that the required resource amount corresponding to the current mode ID “2” of the extracted entry is 35.

Similarly, the mode requirement DB 308 in FIG. 8 shows that the total amount of the required resources corresponding to an operating mode ID of 3 (corresponding to the assumed mode ID of the entry 512 in FIG. 6) is 110 (100 (the required resource amount of the entry 715)+10 (the required resource amount of the entry 716). Therefore, the assumption determining part 303 determines that the required resource amount corresponding to the assumed mode ID “3” of the extracted entry is 110.

As a result, in this case, the assumption determining part 303 determines that the required resource amount corresponding to the assumed mode ID of the extracted entry exceeds the required resource amount corresponding to the current mode ID of the same entry in the mode requirement DB 308. In this case, the operation proceeds to the step S1105. Note that the above determination method based on the total amount of the required resource amount is an example, and the determination method in the process of the step S1104 is not limited thereto.

In the step S1105, the assumption determining part 303 determines whether or not the assumed mode can be accommodated by the current infrastructure. This means whether or not the operating mode corresponding to the assumed mode is able to run on the current infrastructure. Here, the current infrastructure includes the network infrastructure 102 and/or the computing infrastructure 105.

More specifically, the assumption determining part 303 determines whether or not the assumed mode corresponding to the assumed mode ID of the assumption candidate entry can run on the terminal 103 corresponding to the terminal ID of the assumption candidate entry with the current infrastructure on the basis of the infrastructure resource DB 307 and the mode requirement DB 308.

For instance, the assumption determining part 303 may determine whether or not the assumed mode can be accommodated by the current infrastructure on the basis of the difference between the required resource amount corresponding to the assumed mode ID and the required resource amount corresponding to the current mode ID. In this case, the assumption determining part 303 may determine that the current infrastructure is able to accommodate the assumed mode when the difference is not more than the remaining amount of resources. Conversely, when the difference exceeds the remaining amount of resources, the assumption determining part 303 may determine that the current infrastructure is not able to accommodate the assumed mode.

Further, for instance, the assumption determining part 303 may calculate the remaining amount of resources on the basis of the difference between the resource total amount and the resource usage in the infrastructure resource DB 307 shown in FIG. 7.

When the current infrastructure is able to accommodate the assumed mode (Yes in the step S1105), the operation proceeds to step S1106. Conversely, when the current infrastructure is not able to accommodate the assumed mode (No in the step S1105), the assumption determining part 303 flags the entry extracted from the mode DB 306 as “processed” (the step S1107). Then the operation returns to the step 1102 and the processing continues.

For instance, the assumption determining part 303 may extracts the entry 512 shown in FIG. 6 as an assumption candidate entry and that the assumption determining part 303 determines whether or not the current infrastructure is able to accommodate the assumed mode on the basis of the difference between the required resource amount corresponding to the assumed mode ID and the required resource amount corresponding to the current mode ID.

In this case, the mode requirement DB 308 in FIG. 8 shows that the required resource amount of the resource ID “1” corresponding to the assumed mode ID “3” is 100. Further, the mode requirement DB 308 in FIG. 8 shows that the required resource amount of the resource ID “1” corresponding to the current mode ID “2” is 25. Therefore, as far as the resource having the resource ID of 1 is concerned, the difference between the required resource amount corresponding to the assumed mode ID and the required resource amount corresponding to the current mode ID is 75.

Similarly, the mode requirement DB 308 in FIG. 8 shows that the required resource amount of the resource ID “2” corresponding to the assumed mode ID “3” is 10. Further, the mode requirement DB 308 in FIG. 8 shows that the required resource amount of the resource ID “2” corresponding to the current mode ID “2” is 10.

Further, the infrastructure resource DB 307 shown in FIG. 7 shows that the remaining amount of the resource of the resource ID “1” (the difference between the resource total amount and the resource usage) is 95. Similarly, the infrastructure resource DB 307 in FIG. 7 shows that the remaining amount of the resource of the resource ID “2” is 110. Therefore, in this case, the assumption determining part 303 determines that the current infrastructure is able to accommodate the assumed mode. Then the operation proceeds to the step S1106.

In the step S1106, the assumption determining part 303 sets the assumption flag corresponding to the extracted entry to “Y” in the mode DB 306. More specifically, the assumption determining part 303 determines the terminal 103 corresponding to the terminal ID of the assumption target entry to be a control target terminal to be controlled with the assumption that the operating state has changed before the operating state changes. Then the assumption determining part 303 sets the assumption flag corresponding to this control target terminal to “Y” in the mode DB 306. Further, the assumption determining part 303 sets the assumption flags corresponding to terminals other than the control target terminal to “N” in the mode DB 306. Then the assumption determining part 303 flags the entry extracted from the mode DB 306 as “processed” (the step S1107).

Then the operation returns to the step S1102 and the process continues. In other words, the process continues until all the entries in the mode DB 306 are flagged as processed. The assumption determining part 303 updates the assumption flag stored in the mode DB 306 by executing the processing described above (the processing shown in FIG. 12).

Next, the operation of the control information transmission part 304 will be described in detail with reference to FIG. 13. FIG. 13 is a flowchart showing an example of the operation of the control information transmission part 304.

In step S1201, the control information transmission part 304 sets a flag indicating “unprocessed” for each entry stored in the mode DB 306. More specifically, all the entries stored in the mode DB 306 are extracted. Then the control information transmission part 304 sets the flag indicating “unprocessed” for each of the extracted entries.

In step S1202, the control information transmission part 304 determines whether or not there is any unprocessed entry in the mode DB 306. In other words, the control information transmission part 304 determines if there is any entry flagged as “unprocessed” in the mode DB 306. When there is any unprocessed entry in the mode DB 306 (Yes in the step S1202), an unprocessed entry is extracted and the operation proceeds to step S1203. Conversely, when there is no unprocessed entry in the mode DB 306 (No in the step S1202), the control information transmission part 304 determines that all the entries in the mode DB 306 have been processed and ends the processing.

In the step 1203, the control information transmission part 304 determines whether or not the terminal 103 corresponding to the entry extracted from unprocessed entries in the mode DB 306 is a control target terminal. More specifically, when referring to the mode DB 306 shown in FIG. 6, the control information transmission part 304 determines whether or not the terminal 103 corresponding to the entry is a control target terminal on the basis of the assumption flag of the entry extracted from unprocessed entries in the mode DB 306. Note that the terminal 103 corresponding to the extracted entry is the terminal 103 corresponding to the terminal ID of the entry.

When the terminal 103 corresponding to the extracted entry is a control target terminal (Yes in the step S1203), the control information transmission part 304 transmits parameters required in the assumed mode and the terminal ID of the extracted entry to the infrastructure control apparatus 104 (step S1204). More specifically, the control information transmission part 304 calculates parameters (control information) required in the assumed mode of the terminal 103 (i.e., control target terminal) corresponding to the extracted entry on the basis of the mode requirement DB 308. For instance, the control information transmission part 304 may refer to the mode requirement DB 308 and extract the resource ID and the required resource amount corresponding to the assumed mode ID. Then the control information transmission part 304 may calculate parameters required in the assumed mode on the basis of the extracted resource ID and required resource amount. Then the control information transmission part 304 transmits the calculated parameters and the terminal ID of the extracted entry (i.e., the terminal ID of the control target terminal) to the infrastructure control apparatus 104. Then the operation returns to the step S1202 and the process continues.

Conversely, when the terminal 103 corresponding to the extracted entry is not a control target terminal (No in the step S1203), the control information transmission part 304 transmits parameters required in the current mode and the terminal ID of the extracted entry to the infrastructure control apparatus 104 (step S1205). More specifically, the control information transmission part 304 calculates parameters (control information) required in the current mode of the terminal 103 (i.e., terminal 103 that is not a control target terminal) corresponding to the extracted entry on the basis of the mode requirement DB 308. For instance, the control information transmission part 304 may refer to the mode requirement DB 308 and extract the resource ID and the required resource amount corresponding to the current mode ID. Then the control information transmission part 304 may calculate parameters (control information) required in the current mode on the basis of the extracted resource ID and required resource amount. Then the control information transmission part 304 transmits the calculated parameters and the terminal ID of the extracted entry to the infrastructure control apparatus 104. Then the operation returns to the step S1202 and the process continues.

The infrastructure control apparatus 104 receives the parameters transmitted from the QoE ensuring apparatus 101 as information (control information) required to control the network infrastructure 102 and/or the computing infrastructure 105. Then the infrastructure control apparatus 104 controls the network infrastructure 102 and/or the computing infrastructure 105 on the basis of the received control information.

As described above, the QoE ensuring apparatus 101 relating to the present exemplary embodiment selects a terminal 103 having a higher degree of priority from a plurality (two or more) of the terminals 103 as a control target terminal to be controlled before the operating state (operating mode) changes. Further, the QoE ensuring apparatus 101 relating to the present exemplary embodiment presumes, as the assumed mode, a next operating state (operating mode) to which the operating state (current mode) of each terminal 103 will transition. Further, the QoE ensuring apparatus 101 transmits the required parameters (control information) to the infrastructure control apparatus 104 so as to perform control for the selected control target terminal before the operating state (operating mode) changes. As a result, the QoE ensuring apparatus 101 relating to the present exemplary embodiment contributes to suppressing the degradation of QoE due to the transition of the operating state of an application.

### Second Exemplary Embodiment

Next, a second exemplary embodiment will be described in detail with reference to the drawings.

In the present exemplary embodiment, the state transition probability between the operating modes is estimated on the basis of the history of the operating modes. Note that, in the description of the present exemplary embodiment, the description of sections overlapping with the exemplary embodiment described above will be omitted. Further, in the description of the present exemplary embodiment, the same signs are given to the same elements as those in the exemplary embodiment above, and the explanation thereof will be omitted. Further, the description of the same effects as those in the exemplary embodiment above will be omitted in the description of the present exemplary embodiment. These statements also apply to the other exemplary embodiments.

An example of an overall configuration of a networked system relating to the present exemplary embodiment is as shown in FIG. 2. Further, in the description of the present exemplary embodiment, the terminal and the QoE ensuring apparatus are referred to as terminal 1301 and QoE ensuring apparatus 1401, respectively.

First, the terminal 1301 relating to the present exemplary embodiment will be described in detail.

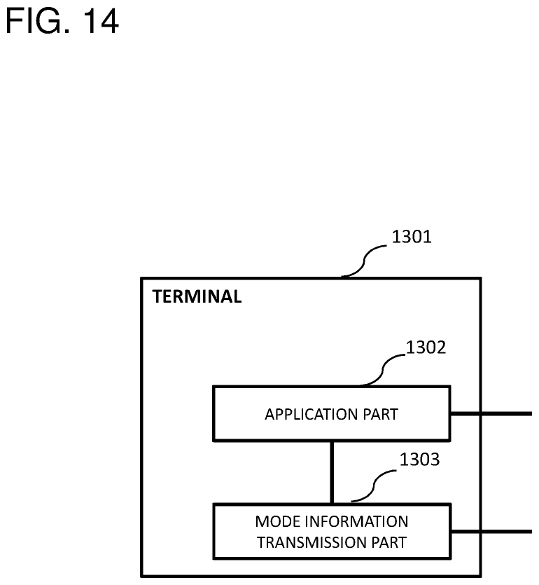

FIG. 14 is a block diagram showing an example of an internal configuration of the terminal 1301 relating to the present exemplary embodiment. The terminal 1301 relating to the present exemplary embodiment is configured to include an application part 1302 and a mode information transmission part 1303. Since the application part 1302 relating to the present exemplary embodiment is identical to the application part 201 relating to the first exemplary embodiment, a detailed explanation will be omitted. The differences between the terminal 1301 relating to the present exemplary embodiment and the terminal 103 relating to the first exemplary embodiment will be described below.

For instance, a storage device (not shown in the drawing) provided in the terminal 1301 may store the client-side application 107.

The storage device is realized by a magnetic disk device, optical disk device, or semiconductor memory.

The terminal 1301 may implement the application part 1302 and the mode information transmission part 1303 using a CPU. Further, for instance, the terminal 1301 may exchange data (information) with the other apparatuses (the QoE ensuring apparatus 1401, the network infrastructure 102, and the computing infrastructure 105) using a NIC.

The mode information transmission part 1303 observes (monitors) the operating state of the application part 1302. Further, the mode information transmission part 1303 obtains the operating modes switched internally by the client-side application 107. When the operating mode is updated, the mode information transmission part 1303 notifies the QoE ensuring apparatus 1401 that the operating mode has been updated via the network infrastructure 102.

Next, the QoE ensuring apparatus 1401 relating to the present exemplary embodiment will be described in detail.

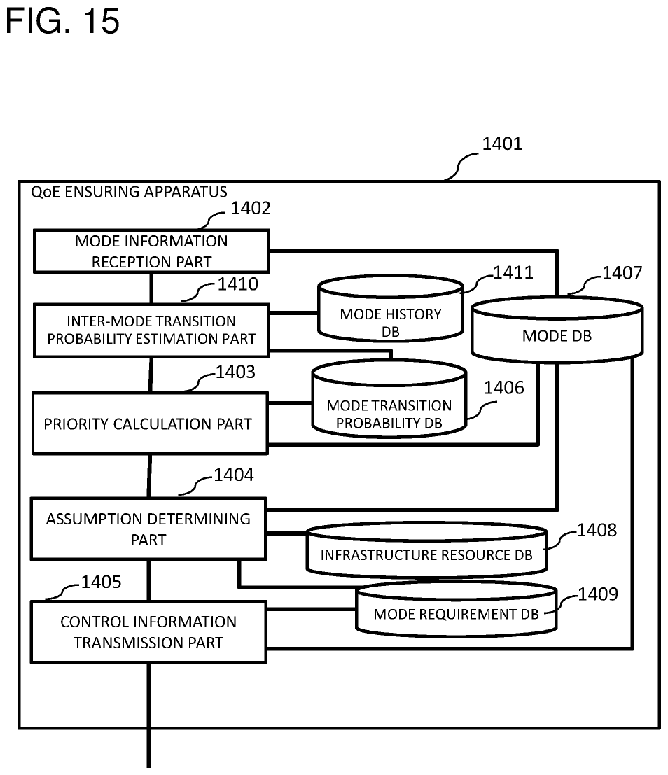

FIG. 15 is a block diagram showing an example of an internal configuration of the QoE ensuring apparatus 1401 relating to the present exemplary embodiment. The QoE ensuring apparatus 1401 relating to the present exemplary embodiment is configured to include a mode information reception part 1402, a priority calculation part 1403, an assumption determining part 1404, a control information transmission part 1405, and an inter-mode transition probability estimation part (also referred to as state transition probability estimation part) 1410. Further, The QoE ensuring apparatus 1401 relating to the present exemplary embodiment is configured to include a mode transition probability DB 1406, a mode DB 1407, an infrastructure resource DB 1408, a mode requirement DB 1409, and a mode history DB 1411. The QoE ensuring apparatus 1401 shown in FIG. 15 differs from the QoE ensuring apparatus 101 shown in FIG. 4 in that the QoE ensuring apparatus 1401 in FIG. 15 is configured to include the inter-mode transition probability estimation part 1410 and the mode history DB (also referred to as operating mode history database) 1411. The differences between the QoE ensuring apparatus 1401 relating to the present exemplary embodiment and the QoE ensuring apparatus 101 relating to the first exemplary embodiment will be described in detail below.

For instance, a storage device (not shown in the drawing) provided in the QoE ensuring apparatus 1401 may store the mode transition probability DB 1406, the mode DB 1407, the infrastructure resource DB 1408, the mode requirement DB 1409, and the mode history DB 1411. The storage device is realized by a magnetic disk device, optical disk device, or semiconductor memory.

Further, the QoE ensuring apparatus 1401 may implement the mode information reception part 1402, the priority calculation part 1403, the assumption determining part 1404, the control information transmission part 1405, and the inter-mode transition probability estimation part 1410 using a CPU. Further, for instance, the QoE ensuring apparatus 1401 may exchange data (information) with the other apparatuses (the terminal 1301, the infrastructure control apparatus 104, etc.) using a NIC.

Since information stored in the mode transition probability DB 1406, the mode DB 1407, the infrastructure resource DB 1408, and the mode requirement DB 1409 is the same as in the first exemplary embodiment, a detailed explanation will be omitted. Further, in the following description, the mode transition probability DB 1406, the mode DB 1407, the infrastructure resource DB 1408, and the mode requirement DB 1409 may store the information shown in FIGS. 5, 6, 7, and 8, respectively.

The mode history DB 1411 stores the history of the operating mode of an application on the terminal 1301. More specifically, the mode history DB 1411 stores information identifying a terminal and the history information of the first operating state (actual operating state) of the terminal 1301 while associating these pieces of information with each other.

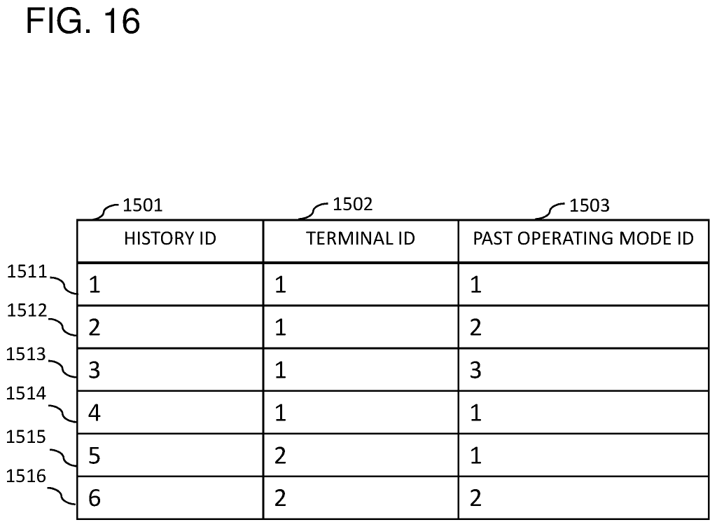

FIG. 16 is a drawing showing an example of the mode history DB 1411. More specifically, FIG. 16 shows a table in which history ID 1501, terminal ID 1502, and past operating mode ID 1503 are associated with each other. The history ID 1501 is the information identifying the history of the operating mode of an application on the terminal 1301. The terminal ID 1502 is the information identifying a terminal 1301. The past operating mode ID 1503 is the information identifying the operating mode that actually operated (transitioned) in an application on the terminal 1301. The mode history DB 1411 in FIG. 16 shows entries 1511 to 1516 associating the history ID 1501, the terminal ID 1502, and the past operating mode ID 1503 with each other.

For instance, the entries 1511, 1512, 1513, and 1514 shown in FIG. 16 indicate that the operating mode of a terminal 1301 having a terminal ID of 1 transitioned in the order of 1, 2, 3, and 1.

The mode information reception part 1402 relating to the present exemplary embodiment registers the current mode ID transmitted by the terminal 1031 in the mode DB 1407. Then the mode information reception part 1402 notifies the inter-mode transition probability estimation part 1410 that the mode DB 1407 has been updated.

The inter-mode transition probability estimation part 1410 calculates the state transition probability on the basis of the history information of the first operating state. More specifically, inter-mode transition probability estimation part 1410 refers to the mode DB 1407 and registers the history information of the first operating state (actual operating state) of the terminal 1310 in the mode history DB 1411.

Then the inter-mode transition probability estimation part 1410 refers to the mode history DB 1411 and estimates the state transition probability between the operating modes. Then the inter-mode transition probability estimation part 1410 registers the estimated state transition probability in the mode transition probability DB 1406.

For instance, the operating mode of the terminal 1301 having the terminal ID of 1 transitions in the order of 1, 2, 3, and 1, and that the mode history DB 1411 may store the entries 1511 to 1514 shown in FIG. 16. In this case, the inter-mode transition probability estimation part 1410 extracts the entries 1511 to 1514 in FIG. 16 from the mode history DB 1411 as the operating mode history for the terminal 1301 having the terminal ID of 1.

Then the inter-mode transition probability estimation part 1410 estimates the state transition probability between the operating modes on the basis of the extracted entries 1511 to 1514 shown in FIG. 16. For instance, the inter-mode transition probability estimation part 1410 may model the relationship between the operating modes using a Hidden

Markov Model and estimate the state transition probability using the Baum-Welch algorithm. Note that this is an example of the method for estimating the state transition probability, and the method for estimating the state transition probability is not limited thereto.

Next, the operation of the networked system relating to the present exemplary embodiment will be described.

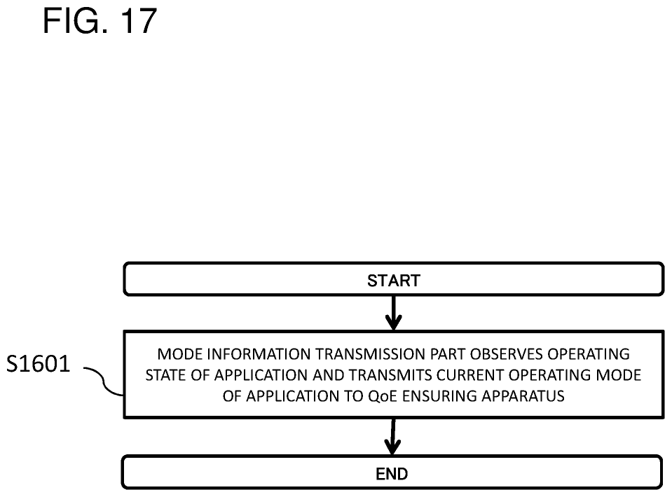

First, the operation of the terminal 1301 will be described with reference to FIG. 17. FIG. 17 is a flowchart showing an example of the operation of the terminal 1301.

In step S1601, the mode information transmission part 1303 observes the state of an application, and transmits the current operating mode of the application to the QoE ensuring apparatus 1401. More specifically, the mode information transmission part 1303 obtains the operating modes switched internally by the client-side application 107, and transmits the operating mode to the QoE ensuring apparatus 1401 when the operating mode has been updated.

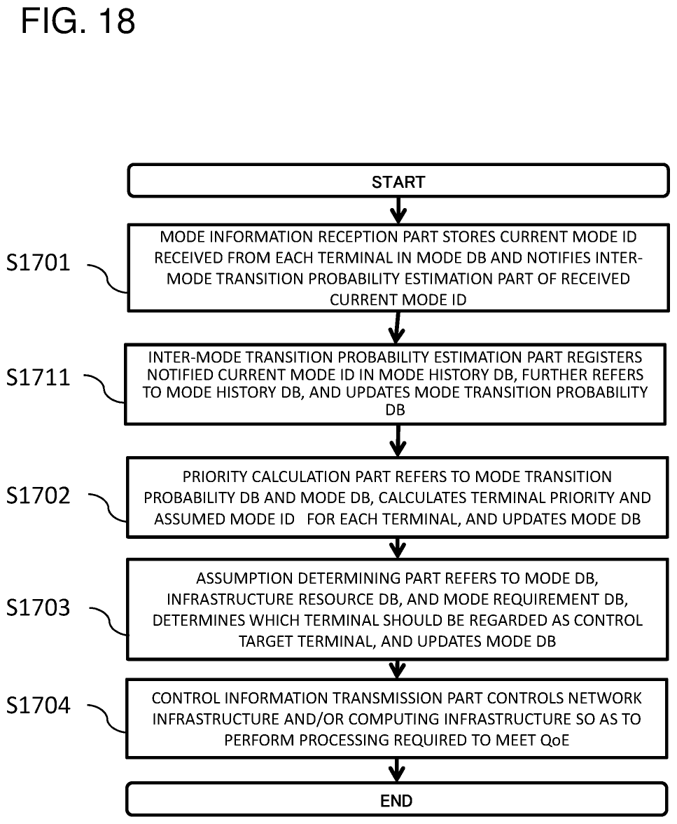

Next, the operation of the QoE ensuring apparatus 1401 will be described with reference to FIG. 18. FIG. 18 is a flowchart showing an example of the operation of the QoE ensuring apparatus 1401.

In step S1701, the mode information reception part 1402 stores the current mode ID received from each of the terminals 1301 in the mode DB 1407, and notifies the inter-mode transition probability estimation part 1410 of the received current mode IDs.

In step S1711, the inter-mode transition probability estimation part 1410 registers the notified current mode IDs in the mode history DB 1411, further refers to the mode history DB 1411, and updates the mode transition probability DB 1406.

Then the QoE ensuring apparatus 1401 executes processes of steps S1702 to S1704 shown in FIG. 18. Since the steps S1702 to S1704 in FIG. 18 are the same as the steps S902 to S904 shown in FIG. 10, a detailed explanation will be omitted.

As described, the QoE ensuring apparatus 1401 relating to the present exemplary embodiment estimates the state transition probability between the operating modes on the basis of the history of the operating mode of an application running on the terminal 1301. Therefore, in the networked system relating to the present exemplary embodiment, even when the terminal 1301 is unable to transmit the state transition probability between the operating modes to the QoE ensuring apparatus 1401, the QoE ensuring apparatus 1401 is able to estimate (derive) the state transition probability between the operating modes. In the networked system relating to the present exemplary embodiment, even when the terminal 1301 is unable to transmit the state transition probability between the operating modes to the QoE ensuring apparatus 1401, the QoE ensuring apparatus 1401 transmits required parameters (control information) to the infrastructure control apparatus 104 so as to perform control in advance before the operating state (operating mode) changes. As a result, even when the terminal 1301 is unable to transmit the state transition probability between the operating modes to the QoE ensuring apparatus 1401, the networked system relating to the present exemplary embodiment contributes to suppressing the degradation of QoE due to the transition of the operating state of an application.

### Third Exemplary Embodiment

Next, a third exemplary embodiment will be described in detail with reference to the drawings.

In the present exemplary embodiment, an application running on a terminal is controlled with the assumption that the operating mode of the terminal has changed before the operating mode changes.

An example of an overall configuration of a networked system relating to the present exemplary embodiment is as shown in FIG. 2. Further, in the description of the present exemplary embodiment, the terminal and the QoE ensuring apparatus are referred to as terminal 1801 and QoE ensuring apparatus 1901, respectively.

First, the terminal 1801 relating to the present exemplary embodiment will be described in detail.

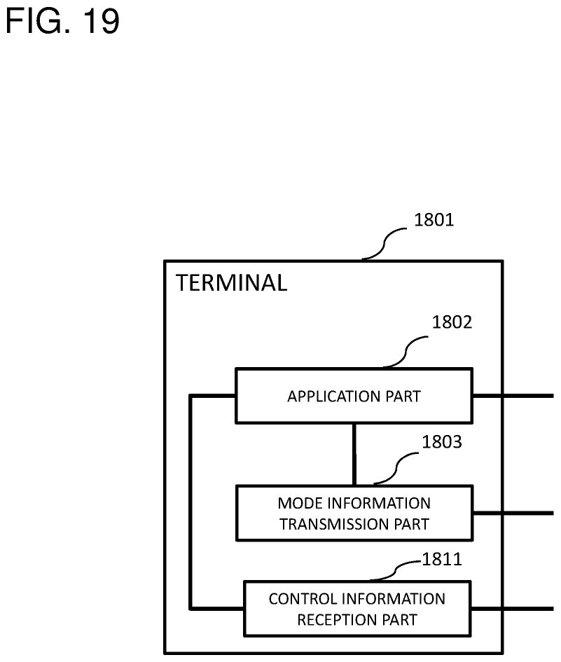

FIG. 19 is a block diagram showing an example of an internal configuration of the terminal 1801 relating to the present exemplary embodiment. The terminal 1801 relating to the present exemplary embodiment is configured to include an application part 1802, a mode information transmission part 1803, and a control information reception part 1811. The terminal 1801 shown in FIG. 19 differs from the terminal 103 shown in FIG. 3 in that the terminal 1801 in FIG. 19 is configured to include the control information reception part 1811. Since the application part 1802 and the mode information transmission part 1803 relating to the present exemplary embodiment are identical to the application part 201 and the mode information transmission part 202 relating to the first exemplary embodiment, a detailed explanation will be omitted. The differences between the terminal 1801 relating to the present exemplary embodiment and the terminal 103 relating to the first exemplary embodiment will be described below.

The terminal 1801 may implement the application part 1802, the mode information transmission part 1803, and the control information reception part 1811 using a CPU. Further, for instance, the terminal 1801 may exchange data (information) with the other apparatuses (the QoE ensuring apparatus 1901, the network infrastructure 102, and the computing infrastructure 105) using a NIC.

The control information reception part 1811 controls the operation of the application part 1802 using control information (parameters required in the assumed mode, etc.) transmitted by the QoE ensuring apparatus 1901. More specifically, the control information reception part 1811 sets and updates the parameters for the operation of an application (the client-side application 107) running on the terminal 1801 using the control information transmitted by the QoE ensuring apparatus 1901. As a result, the control information reception part 1811 dynamically changes the operating mode and the parameters of an application running on the terminal 1801 using the control information transmitted by the QoE ensuring apparatus 1901.

Next, the QoE ensuring apparatus 1901 relating to the present exemplary embodiment will be described in detail.

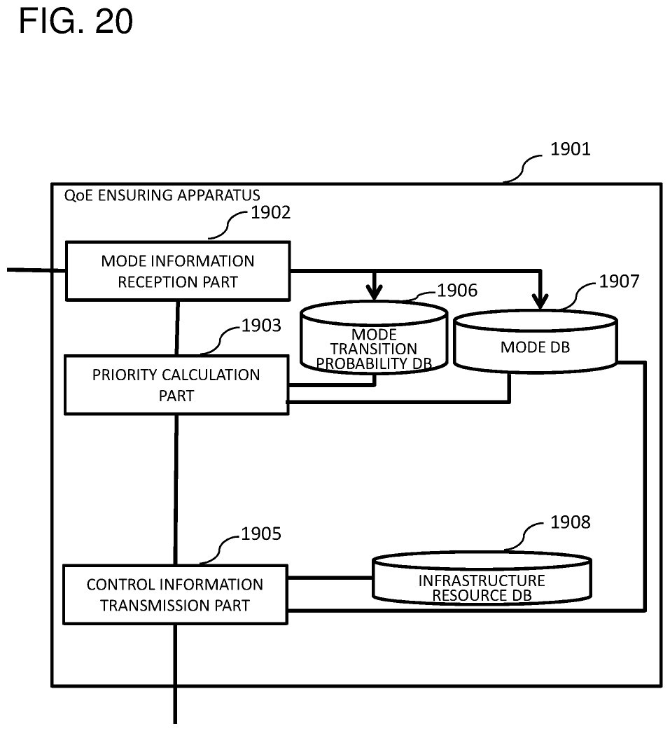

FIG. 20 is a block diagram showing an example of an internal configuration of the QoE ensuring apparatus 1901 relating to the present exemplary embodiment. The QoE ensuring apparatus 1901 is configured to include a mode information reception part 1902, a priority calculation part 1903, and a control information transmission part 1905. Further, The QoE ensuring apparatus 1901 is configured to include a mode transition probability DB 1906, a mode DB 1907, and an infrastructure resource DB 1908. The QoE ensuring apparatus 1901 shown in FIG. 20 differs from the QoE ensuring apparatus 101 shown in FIG. 4 in that The QoE ensuring apparatus 1901 in FIG. 20 does not have the assumption determining part 303 and the mode requirement DB 308 of the QoE ensuring apparatus 101 in FIG. 4.

For instance, a storage device (not shown in the drawing) provided in the QoE ensuring apparatus 1901 may store the mode transition probability DB 1906, the mode DB 1907, and the infrastructure resource DB 1908. The storage device is realized by a magnetic disk device, optical disk device, or semiconductor memory.

Further, the QoE ensuring apparatus 1901 may implement the mode information reception part 1902, the priority calculation part 1903, and the control information transmission part 1905 using a CPU. Further, for instance, the QoE ensuring apparatus 1901 may exchange data (information) with the other apparatuses (the terminal 1801, the infrastructure control apparatus 104, etc.) using a NIC.

The control information transmission part 1905 relating to the present exemplary embodiment refers to the mode DB 1907 and the infrastructure resource DB 1908, and calculates control information. Then the control information transmission part 1905 transmits the calculated control information to the terminal 1801. The control information transmitted by the control information transmission part 1905 includes the assumed mode ID and the terminal priority stored in the mode DB 1907, and the information regarding resources stored in the infrastructure resource DB 1908.

Next, the operation of the networked system relating to the present exemplary embodiment will be described.

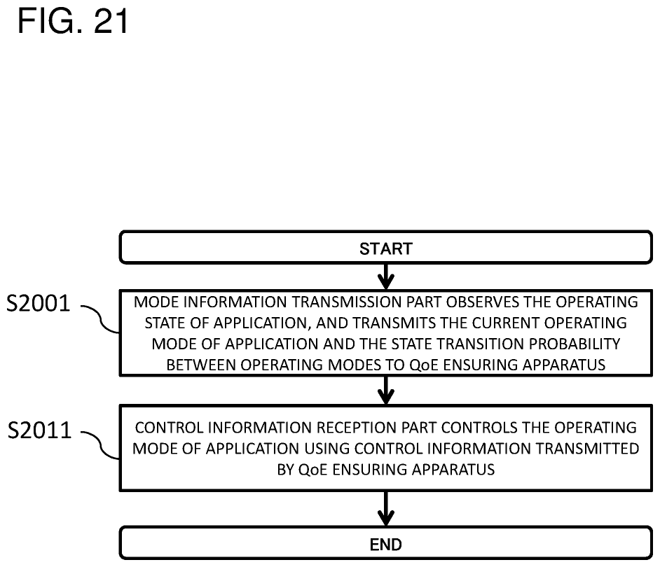

First, the operation of the terminal 1801 will be described with reference to FIG. 21. FIG. 21 is a flowchart showing an example of the operation of the terminal 1801.

In step S2001, the mode information transmission part 1803 observes the operating state of an application, and transmits the current operating mode of the application and the state transition probability between the operating modes to the QoE ensuring apparatus 1901.

In step S2011, the control information reception part 1811 controls the operating mode of the application using the control information transmitted by the QoE ensuring apparatus 1901. More specifically, the control information reception part 1811 receives the use state of the infrastructure (the network infrastructure 102 and/or the computing infrastructure 105) from the QoE ensuring apparatus 1901.

For instance, when there is room in the use state of the network infrastructure 102 and the computing infrastructure 105, the control information reception part 1811 may set the parameters so as to increase the frequency of data transmission to the infrastructure (the network infrastructure 102 and/or the computing infrastructure 105).

Further, the control information reception part 1811 may directly receive the assumed mode ID from the QoE ensuring apparatus 1901. Then the control information reception part 1811 may set the required parameters so as to perform control in advance before the operating state (operating mode) changes. Note that this is an example of the method for controlling the terminal 1801 in advance before the operating state (operating mode) changes, and is not intended to limit the method for controlling the terminal 1801 with the assumption that the operating state has changed before the operating state changes.

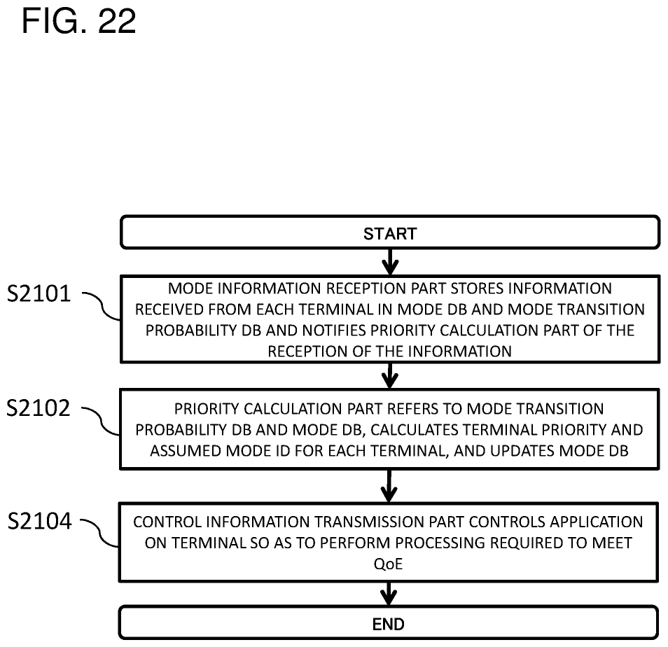

Next, the operation of the QoE ensuring apparatus 1901 will be described with reference to FIG. 22. FIG. 22 is a flowchart showing an example of the operation of the QoE ensuring apparatus 1901.

In step S2101, the mode information reception part 1902 stores information received from each terminal 1801 in the mode transition probability DB 1906 and the mode DB 1907, and notifies the priority calculation part 1903 of the reception of the information.

In step S2102, the priority calculation part 1903 refers to the mode DB 1907 and the mode transition probability DB 1906, calculates the terminal priority and the assumed mode ID for each terminal 1801, and updates the mode DB 1907.

In step S2104, the control information transmission part 1905 controls the application on the terminal 1801 so as to perform processing required to meet QoE. More specifically, the control information transmission part 1905 refers to the mode DB 1907 and the infrastructure resource DB 1908, and calculates the control information. Then the control information transmission part 1905 transmits the calculated control information to the terminal 1801.

As described above, the QoE ensuring apparatus 1901 relating to the present exemplary embodiment transmits the assumed mode ID and the terminal priority and information regarding the infrastructure resources to the terminal 1801 as the control information. As a result, in the networked system relating to the present exemplary embodiment, even when the infrastructure cannot be directly controlled, the terminal 1801 dynamically changes the operating mode and the parameters of the application running on the terminal 1801 using the received control information. Therefore, the networked system relating to the present exemplary embodiment contributes to suppressing the degradation of QoE due to the transition of the operating state of an application even when the infrastructure cannot be directly controlled.

Some or all of the exemplary embodiments above can be described as (but not limited to) the following modes.

(Mode 1) As the control apparatus relating to the first aspect.

(Mode 2) The control apparatus, wherein the operating state includes a plurality of discrete operating modes of an application.

(Mode 3) The control apparatus further comprising an operating mode database that stores information identifying a terminal, the operating mode of the first operating state, the operating mode of the second operating state, the terminal priority, and information indicating whether or not the terminal is the control target terminal while associating these pieces of information with each other.

(Mode 4) The control apparatus, wherein the first operating state includes the operating mode currently running in an application and the state transition probability between the operating modes.

(Mode 5) The control apparatus, wherein the second operating state presuming part presumes the terminal priority and the second operating state on the basis of the state transition probability between the operating modes.

(Mode 6) The control apparatus further comprising a state transition probability estimation part that derives the state transition probability between the operating modes on the basis of history information of the first operating state.

(Mode 7) The control apparatus further comprising an operating mode history database that stores information identifying a terminal and the history information of the first operating state of the terminal while associating these pieces of information with each other.

(Mode 8) The control apparatus further comprising an operating mode transition probability database that stores information identifying a terminal, information identifying an operating mode, and the state transition probability of transitioning to the operating mode while associating these pieces of information with each other.

(Mode 9) The control apparatus, wherein the assumption determining part specifies the control target terminal on the basis of the remaining amount of network resources and/or the remaining amount of computing infrastructure resources.

(Mode 10) The control apparatus further comprising an operating mode requirement database that stores information identifying an operating mode, information identifying a resource, and the amount of the resource required to execute the operating mode while associating these pieces of information with each other.

(Mode 11) The control apparatus, wherein

the assumption control part executes the predetermined processing on at least one of a network device, server, or application running on the control target terminal assuming that the operating state of the control target terminal has changed to the second operating state presumed by the second operating state presuming part before the operating state of the control target terminal changes.

(Mode 12) As the control system relating to the second aspect.

(Mode 13) As the control method of a control apparatus relating to the third aspect.

(Mode 14) As the program relating to the fourth aspect.

The modes described in Modes 12 to 14 can be developed into modes described in Modes 2 to 11 as the mode described in Mode 1.

Further, the disclosure of each Patent Literature cited above is incorporated herein in its entirety by reference thereto. It is to be noted that it is possible to modify or adjust the exemplary embodiments within the whole disclosure of the present invention (including the Claims) and based on the basic technical concept thereof. Further, it is possible to variously combine or select a wide variety of the disclosed elements (including the individual elements of the individual claims, the individual elements of the individual exemplary embodiments and the individual elements of the individual figures) within the whole disclosure of the present invention. That is, it is self-explanatory that the present invention includes any types of variations and modifications to be done by a skilled person according to the whole disclosure including the Claims, and the technical concept of the present invention. Particularly, any numerical ranges disclosed herein should be interpreted that any intermediate values or subranges falling within the disclosed ranges are also concretely disclosed even without specific recital thereof.

### REFERENCE SIGNS LIST

1: control apparatus
11: first operating state reception part
12: second operating state presuming part
13, 303, 1404: assumption determining part
14: assumption control part
101, 1401, 1901: QoE ensuring apparatus
102: network infrastructure
103, 103a to 103c, 1301, 1801: terminal
104: infrastructure control apparatus
105: computing infrastructure
106: server-side application
107, 107a to 107c: client-side application
201, 1302, 1802: application part
202, 1303, 1803: mode information transmission part
301, 1402, 1902: mode information reception part
302, 1403, 1903: priority calculation part
304, 1405, 1905: control information transmission part
305, 1406, 1906: mode transition probability DB
306, 1407, 1907: mode DB
307, 1408, 1908: infrastructure resource DB
308, 1409: mode requirement DB
401, 501, 1502: terminal ID
402: transition destination mode ID
403: state transition probability
411 to 416, 511, 512, 611, 612, 711 to 716, 1511 to 1516: entry
502: current mode ID
503: assumed mode ID
504: terminal priority
505: assumption flag
601, 702: resource ID
602: resource total amount
603: resource usage
701: operating mode ID
703: required resource amount
1410: inter-mode transition probability estimation part
1411: mode history DB
1501: history ID
1503: past operating mode ID
1811: control information reception part

1. A control apparatus comprising:
a first operating state reception part that receives the operating state of an application as a first operating state from two or more terminals;
a second operating state presuming part that presumes terminal priority and a second operating state to which the first operating state transits, for each of the terminals on the basis of the first operating state received by the first operating state reception part;
an assumption determining part that specifies as a control target terminal a terminal to be controlled with the assumption that the operating state has changed before the operating state changes on the basis of the terminal priority and the second operating state; and
an assumption control part that executes predetermined processing assuming that the operating state of the control target terminal has changed to the second operating state presumed by the second operating state presuming part before the operating state of the control target terminal changes.

2. The control apparatus according to claim 1, wherein the operating state includes a plurality of discrete operating modes of an application.

3. The control apparatus according to claim 2 further comprising an operating mode database that stores information identifying a terminal, the operating mode of the first operating state, the operating mode of the second operating state, the terminal priority, and information indicating whether or not the terminal is the control target terminal while associating these pieces of information with each other.

4. The control apparatus according to claim 2, wherein the first operating state includes the operating mode currently running in an application and the state transition probability between the operating modes.

5. The control apparatus according to claim 4, wherein the second operating state presuming part presumes the terminal priority and the second operating state on the basis of the state transition probability between the operating modes.

6. The control apparatus according to claim 4 further comprising a state transition probability estimation part that derives the state transition probability between the operating modes on the basis of history information of the first operating state.

7. The control apparatus according to claim 1 further comprising an operating mode history database that stores information identifying a terminal and the history information of the first operating state of the terminal while associating these pieces of information with each other.

8. The control apparatus according to claim 1 further comprising an operating mode transition probability database that stores information identifying a terminal, information identifying an operating mode, and the state transition probability of transitioning to the operating mode while associating these pieces of information with each other.

9. The control apparatus according to claim 1, wherein
the assumption determining part specifies the control target terminal on the basis of the remaining amount of network resources and/or the remaining amount of computing infrastructure resources.

10. The control apparatus according to claim 1 further comprising an operating mode requirement database that stores information identifying an operating mode, information identifying a resource, and the amount of the resource required to execute the operating mode while associating these pieces of information with each other.

11. The control apparatus according to claim 1, wherein
the assumption control part executes the predetermined processing on at least one of a network device, server, or application running on the control target terminal assuming that the operating state of the control target terminal has changed to the second operating state presumed by the second operating state presuming part before the operating state of the control target terminal changes.

12. (canceled)

13. A control method of a control apparatus communicating with two or more terminals via a network, the control method including:
receiving the operating state of an application as a first operating state from the terminals;
presuming terminal priority and a second operating state to which the first operating state will transition for each of the terminals on the basis of the received first operating state;
specifying as a control target terminal a terminal to be controlled with the assumption that the operating state has changed before the operating state changes on the basis of the terminal priority and the second operating state; and
executing predetermined processing assuming that the operating state of the control target terminal has changed to the presumed second operating state before the operating state of the control target terminal changes.

14. A non-transitory computer readable recording medium storing a program executed by a computer controlling a control apparatus communicating with two or more terminals via a network, the recording medium storing a program causing the computer to execute:
receiving the operating state of an application as a first operating state from the terminals;
presuming terminal priority and a second operating state to which the first operating state will transition for each of the terminals on the basis of the received first operating state;
specifying as a control target terminal a terminal to be controlled with the assumption that the operating state has changed before the operating state changes on the basis of the terminal priority and the second operating state; and
executing predetermined processing assuming that the operating state of the control target terminal has changed to the presumed second operating state before the operating state of the control target terminal changes.

15. The control method of the control apparatus according to claim 13, wherein the operating state includes a plurality of discrete operating modes of an application.

16. The control method of the control apparatus according to according to claim 15, wherein the first operating state includes the operating mode currently running in an application and the state transition probability between the operating modes.

17. The control method of the control apparatus according to claim 16, comprising:
presuming the terminal priority and the second operating state on the basis of the state transition probability between the operating modes.

18. The control method of the control apparatus according to claim 16, comprising:
deriving the state transition probability between the operating modes on the basis of history information of the first operating state.

19. The non-transitory computer readable recording medium storing the program according to claim 14, wherein the operating state includes a plurality of discrete operating modes of an application.

20. The non-transitory computer readable recording medium storing the program according to claim 19, wherein the first operating state includes the operating mode currently running in an application and the state transition probability between the operating modes.

21. The non-transitory computer readable recording medium storing the program according to claim 20, the program causing the computer to execute:
presuming the terminal priority and the second operating state on the basis of the state transition probability between the operating modes.
